(19) United States
(12) Patent Application Publication
(10) Pub. No.: US 2008/0298989 A1
(43) Pub. Date: Dec. 4, 2008

(54) ROTARY AND TRANSLATING DISPLACEMENT DEVICE

(76) Inventor: Steven J. Keays, Calgary (CA)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 12/130,811

(22) Filed: May 30, 2008

Related U.S. Application Data
(60) Provisional application No. 60/940,806, filed on May 30, 2007.

(51) Int. Cl. F04B 7/06; F04B 39/10; F16H 29/02

(52) U.S. Cl. 417/500; 417/490; 74/84 R; 74/89; 74/89.14

(57) ABSTRACT

A rotating-to-translating conversion device having a piston member oscillating within a casing where a rotating shaft is positioned through the piston. The interaction between a groove member between the piston and the shaft is such that an engagement member positioned within the groove will provide an oscillating motion of the piston with respect to the shaft, and a sealing system provides a seal between first and second regions within the casing.

### RELATED APPLICATIONS

This application claims priority benefit of U.S. Ser. No. 60/940,806, filed May 30, 2007.

### BACKGROUND OF THE DISCLOSURE

Linear motion-to-rotation conversion devices have been disclosed in the prior art, as described in U.S. Pat. No. 1,389,453. In general, such devices are provided with a roller or other type of engagement member positioned on a casing which is configured to engage a groove, such as the groove 24 shown in FIG. 3 of the piston of the above-noted reference. However, the prior art failed to teach a workable embodiment contending with limitations of seals. For example, the piston as shown in the 1,389,453 application (which is fully incorporated by reference) would require a seal to rotate and translate within the smooth bore of the cylinder.

Rotating to translating devices can be utilized in a plurality of forms. By having a proper set of ports and/or valves access to the interior chamber's can be utilized for a pause displacement type device or alternately utilized to provide a rotational torque from a pressure source from a gas or liquid.

### SUMMARY OF THE DISCLOSURE

Disclosed herein is an energy conversion device having a longitudinal axis where the device is a rotating-to-translating motion converter. Provided for the device is a casing having an interior chamber with first and second region. In one form the casing having a piston limiting feature which can be a really inboard extension only case in or for example could be the shape of the casing such as having an interior elliptical or non-cylindrical shape.

Positioned in the interior chamber is a piston which is configured to and oscillate back and forth therein. The piston is configured to not substantially rotate with respect to the casing. A seal member positioned on the casing to maintain a pressure differential between the first and second regions of the interior chamber. Further a shaft positioned through the piston and configured to rotate therein. A raceway and track-engaging member configured to operate between the shaft and the piston where the raceway is a substantial elliptical pattern having a directional component in the longitudinal direction. The track-engaging member is configured to follow the path of the raceway wherein rotation of the shaft with respect to the piston creates a translating motion of the piston within the interior chamber of the casing. A seal system is provided adjacent to the shaft attached to the piston is configured to have a rotating element that rotates with the shaft to provide a seal as the piston oscillates back and forth along the shaft. further and other seal member can be attached to the piston and engage the rotating seal member so any seal does not have to translate and rotate at the same time in one form of a seal system. For example the rotating element rotating with the shaft to provide a seal is positioned adjacent to a ring, whereas a seal ring is configured to provide a rotating seal. The raceway can be positioned on the shaft or on an interior cylindrical surface of the piston. Other aspects of the disclosure can be appreciated after a reading of a detailed description showing example teachings of the claimed concept.

### BRIEF DESCRIPTION OF THE DRAWINGS

FIG. 1 shows a side partial cross-sectional view of an energy conversion device, more specifically a rotating-to-translating motion conversion device;

FIG. 2 shows a sectional view of the piston;

FIG. 3 is a close-up view of section 3 of FIG. 2 showing a seal system;

FIG. 4 is taken at line 4-4 of FIG. 2 showing one raceway with track engagement members position thereon;

FIG. 5 shows three raceways in a schematic form with the corresponding three track engagement members, each set of track engagement members being denoted by a different style of center line;

FIG. 6 shows a close-up view of a piston engagement member configured to inhibit the rotation of a piston with respect to the casing;

FIGS. 7-10 show various progressive views of the piston moving with respect to the casing given a rotation of the shaft;

FIG. 11 shows another embodiment where first and second piston members are utilized;

FIG. 12 shows a schematic version of the rotating-to-translating motion converter with a power source attached thereto;

FIG. 13 shows a schematic view of one form of upgrading the rotating-to-translating motion converter;

FIG. 14 shows one form of an electric motor embodiment;

FIG. 15 shows another form of an electric motor embodiment.

### DESCRIPTION OF THE PREFERRED EMBODIMENTS

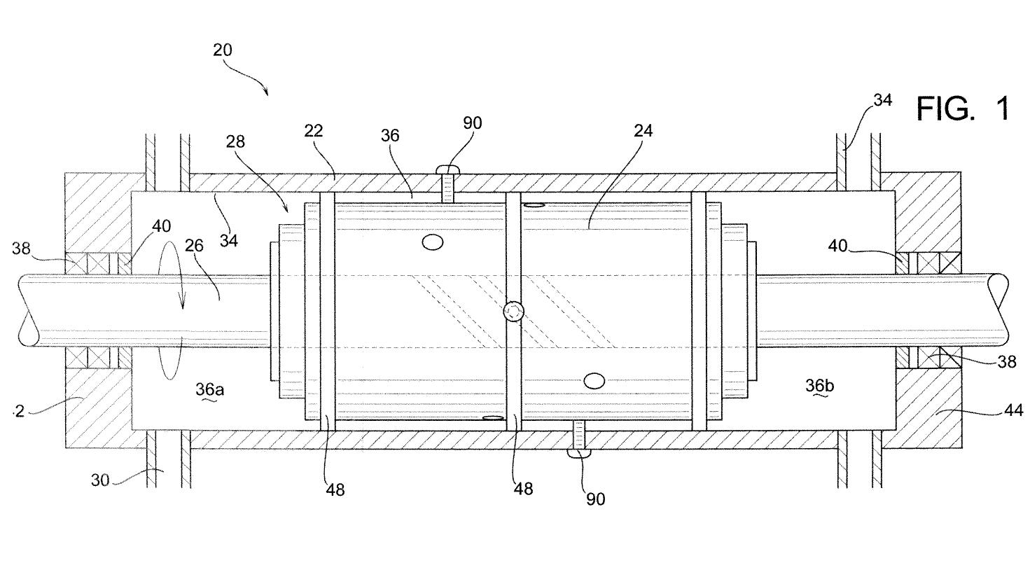

As shown in FIG. 1, there is an energy conversion device 20, otherwise referred to as a rotating-to-translating motion converter. In general, the device 20 comprises a casing 22, a piston 24, a shaft 26, and a seal system 28.

In general, the casing 22 comprises a first passage 30 and a second passage 34. The casing has an interior surface 34 which forms the interior chamber 36. In general, the interior chamber 36 can be divided into a first region 36a and a second region 36b. In one form, the interior chamber 36 is cylindrical; however, it could be of other cross-sectional shapes such as oval, square, polygon, elliptical, or other types of shapes to allow the piston 24 to oscillate therein, which would normally require a consistent cross-sectional area within in the chamber 36.

The casing 22 is operatively configured to have the shaft 26 extend therethrough or at least extend through part of the casing. In one form, the shaft 26 extends through the bearing members 38 as well as through the seal members 40. In general, the shaft can extend all the way through the first and second casing regions for 42 and 44; however, in the broader scope it may not extend entirely therethrough.

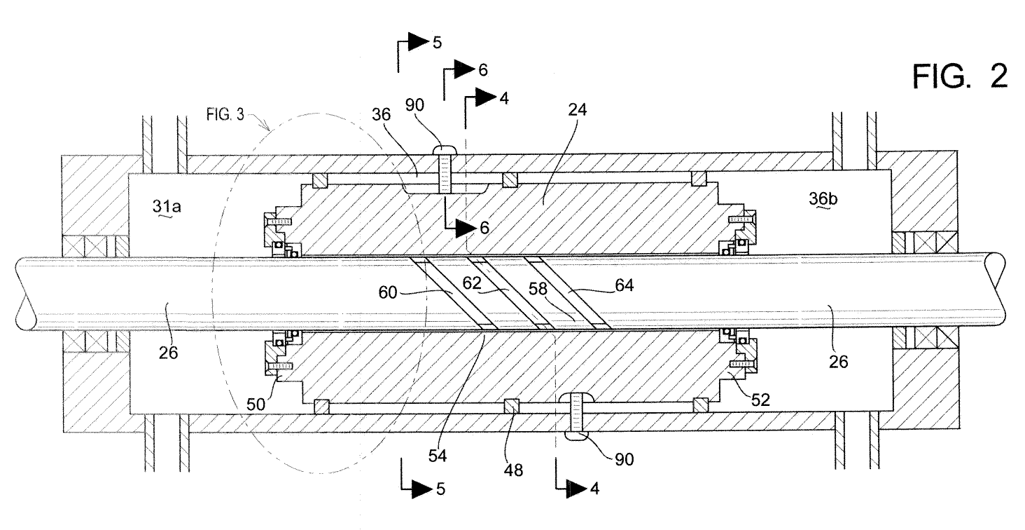

Now referring to FIG. 2, the piston 24 is shown in a cross-sectional view exposing the internal portion 58 of the shaft 26. In general, the piston 24 is operatively configured to reposition in a translating motion within the chamber 36 to and from the first and second chamber regions 36a and 36b. The piston is provided with a plurality of annular seals 48 which extend around the piston to maintain a pressure differential between the first and second regions 36a and 36b. The piston 24 has first and second regions 50 and 52, and further a track-engaging system 54, described further herein.

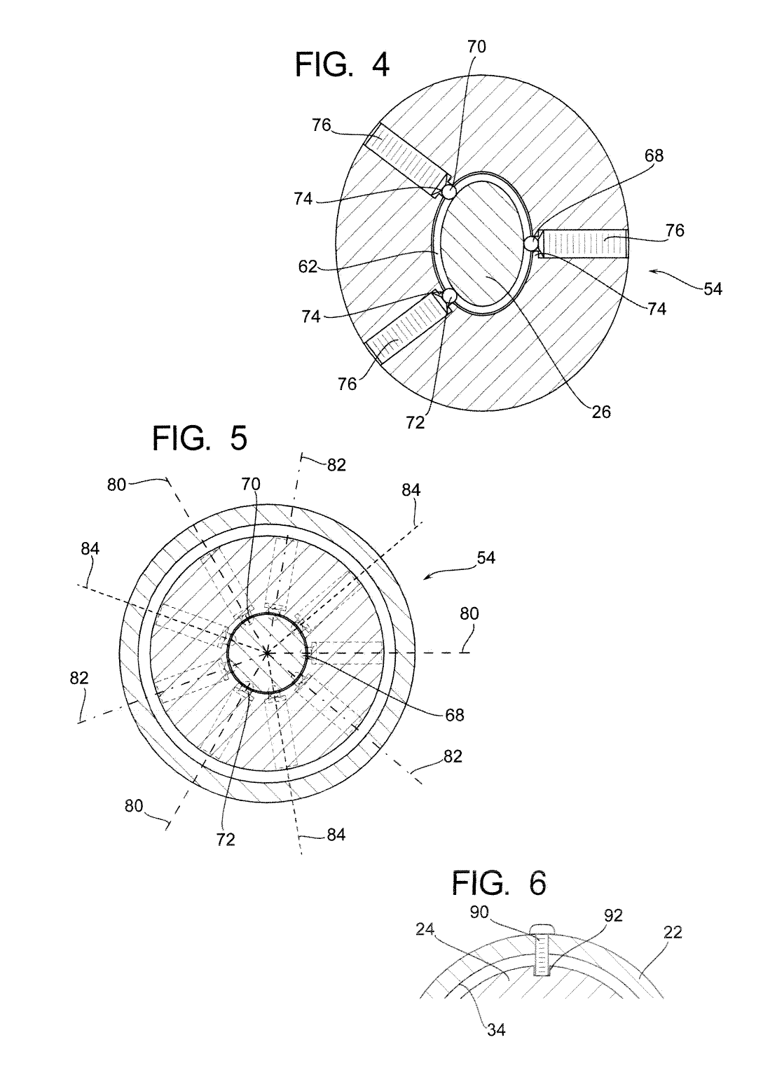

Still referring to FIG. 2, the shaft 26 can be of a substantially conventional design wherein the internal portion 58 is comprised of one or more raceways 60, 62 and 64. The shaft extended a longitudinal direction of the device 20. The raceways are operatively configured to engage the track-engaging system 54 of the piston 24. As shown in FIG. 4, it can be appreciated that the non-linear cross-sectional view shows the raceway 62 of the shaft 26. The track-engaging system 54 comprises one or more track-engaging members 68, 70, and 72, each of which can be spaced in the surface defining the openings 74 within the piston 24. A depth-limiting feature 76 can be provided, such as a threaded member or press-fitted member so as to position the track-engaging members 68, 70 and 72 in proper engagement with the raceway 62. In one form, the track-engaging members are ball bearings or a similar rolling type of device. The track-engaging members can be intermittently utilized per raceway so as if one track-engaging member wears out or otherwise becomes nonfunctional one of the adjacent ones can be employed.

As shown in FIG. 5, it can be appreciated that the track-engaging system 54 can be comprised of three sets of track-engaging members, each engaging (for example) three different tracks. The track-engaging members 68, 70 and 72 could all be positioned within the racetrack 62 at different times in a manner as described above with reference to FIG. 4. It should be noted that the center axis 80 of the racetrack members is of a hatch design, distinguished from the center axis 30° apart therefrom. As an example, the axis 82 denotes a 120° spaced system of track-engaging members, which could engage track 64 as shown in FIG. 2. Further, the track-engaging members corresponding to the axes 84 indicate the spaced relationship of the various track engagement members to engage other track members, such as track 60 as shown in FIG. 2. Of course, the above-noted spacing and number of track members and track-engaging members could vary, but in one form, the above-described track-engaging system 24 can be utilized. Of course, the raceway can be positioned on the interior surface of the piston in the track-engaging members can be positioned on the shaft.

FIG. 6 shows a piston engagement member 90 which is configured to engage a surface defining a longitudinally extending slot 92. The purpose of the piston engagement member is to inhibit rotation of the piston within the casing 22. Of course, a plurality of methods can be utilized, and further, a piston engagement member can be a reconfiguration of the casing's interior surface 34 from a cylindrical-type surface to (for example) an elliptical surface would aid in restricting the rotation of the pistons 24 with respect to the casing 22.

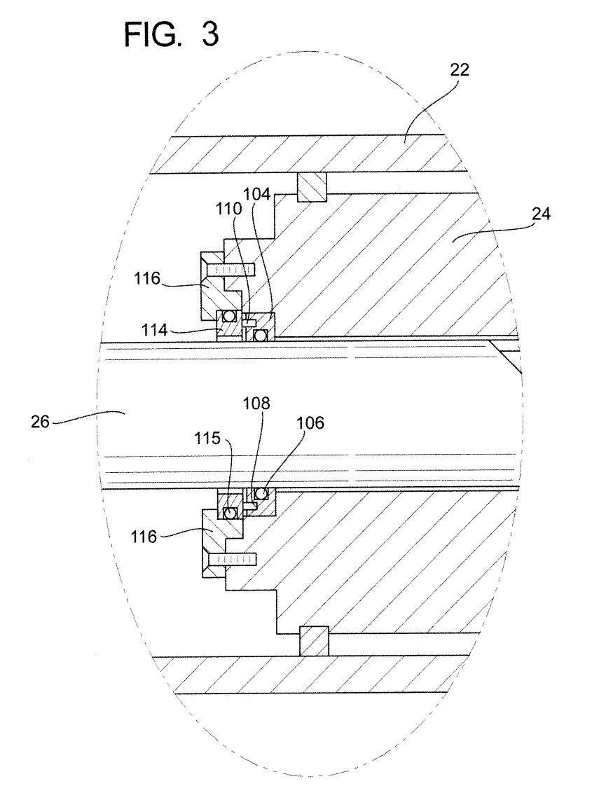

With the foregoing description in place, there will now be a description of the seal system with reference to FIG. 3. As noted in the background of the disclosure, rotating and translating devices have been described in the prior art and are generally utilized for maintaining a pressure differential for biasing fluid or gas within the opposed chambers on opposite regions of the piston member. Of course, maintaining any type of pressure differential would require a seal system. The nature of a rotating-and-translating device does indeed require at least one member to rotate, and one member to translate. Therefore, shown herein with the sealing system 28 is a desirable system to provide a rotating seal member 104 operatively configured to rotate with the shaft 26, and a translating seal member properly configured to reposition back and forth with the piston 24 with respect to the casing 22.

Still referring to FIG. 3, it can be appreciated that the rotating seal member 104 is provided with an annular groove 104 which is configured to provide a seal case for fitting an o-ring-type 106 seal therein. The sealing system is comprised of a rotating seal member 104 and a translating seal member 48. The rotating seal member 104 is operatively configured to rotate with the shaft 26. The O-ring 106 is sealingly engaged to the shaft 26. The rotating seal member 104 has a surface 108 providing an annular chamber region configured to house a seal ring 110. The seal ring 110 is provided with a longitudinally forward surface 112 operatively configured to engage the ring 114. In one form, the ring 114 can be a magnet ring configured to be mounted against the housing 116 which is fastened or otherwise attached to the piston 24. Further, the seal 115 as show in FIG. 3 is provided to maintain a sealing engagement with the housing 116. In one form, a housing 116 is a non-magnetic housing where the rotating seal member 104 and the ring 114 are magnetic engagement-type seal members.

Present analysis indicates that one possible type of seal that could be utilized or modified to be utilized to operate with the energy conversion device is provided by Magseal of Warren, R.I., One possible model number is model 62A, which may be utilized with some modifications thereto.

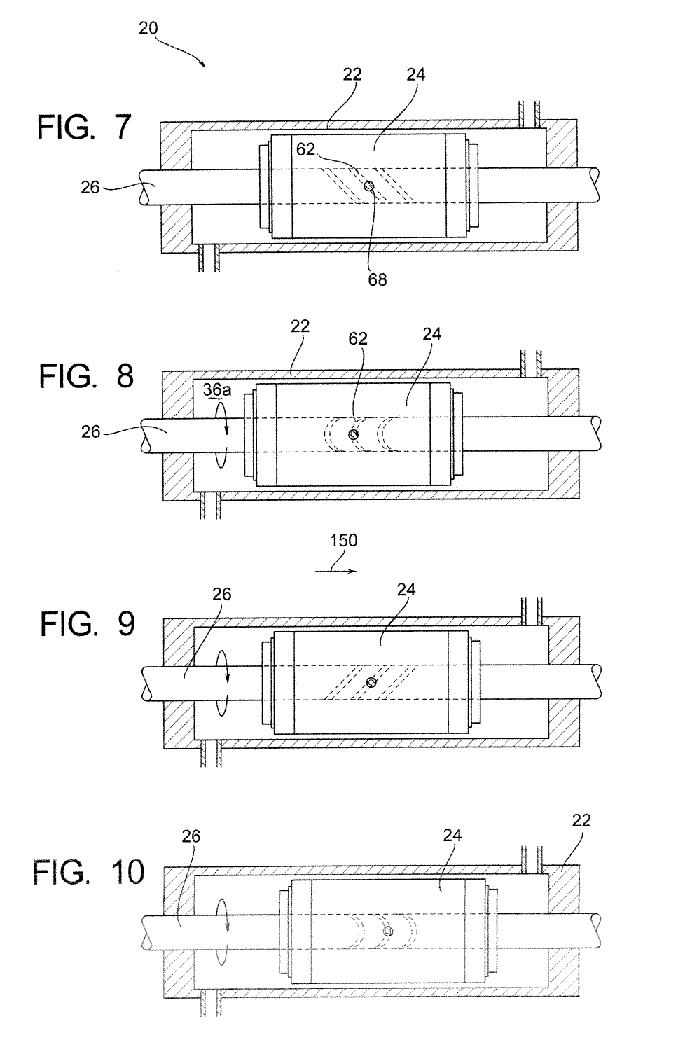

Now referring to FIGS. 7-10, there is shown a progressive set of figures illustrating the rotating and translating device 20 in operation. In general, as shown in FIG. 7, the shaft 26 is at a first position where the piston 24 is located on a central region of the casing 22. For exemplary purposes, the track engagement member 68 will be focused upon to track the motion of the piston 24 with respect to the shaft 26. Of course, the track-engaging member 68 is in engagement with the center raceway 62, which is a part of the shaft 26. As shown in FIG. 8, as the shaft 26 rotates, the track-engaging member 68 will follow therealong and reposition the piston 24 toward the first region 36a of the chamber defined by the casing 22. As shown in FIG. 9, as the shaft continues to rotate, the piston 24 will reposition in the direction indicated by arrow 150, and as shown in FIG. 10, the piston is at an opposing region of the casing with respect to FIG. 8.

Referring to FIG. 13 it can be appreciated that in one form of operation, an inlet source of gas or fluid 160 can be provided with check valves or backflow prevention devices 162. The lines are in communication at the inlet ports 164 and 166. As the piston shown schematically at 24′ oscillates back-and-forth, the contents within the first and second chamber regions 36a and 36b are thereby pumped and ejected through the output lives 168 and 170. Again, check valves or backflow prevention devices 172 can be employed and interposed in the line prior to the output reservoir 174.

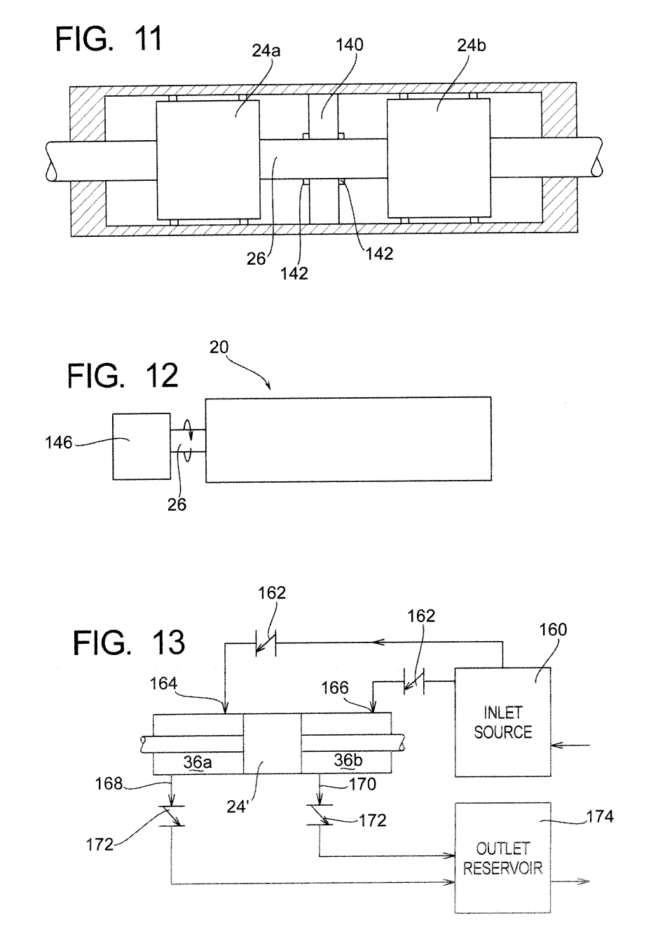

Referring now to FIG. 11, it can be appreciated that first and second piston members 24a and 24b can be employed. In this form, an immediate separation wall 140 can be positioned around the shaft 26. Seal members 142 can be provided to prevent leakage between adjacent chamber regions.

FIG. 12 generally shows the rotating-to-translating motion device 20 operative in conjunction with a power source 146. In general, of course a power source such as an electric motor or other torque-producing device is operatively configured to produce torque upon the shaft 26. Alternatively, fluid or gas can pass through the various chambers within the device 20 to induce rotation of the shaft 26, which is utilized by the device 146 for various forms. In other words, the torque upon the shaft created by the device 20 can be utilized for electric power generation or a plurality of other uses.

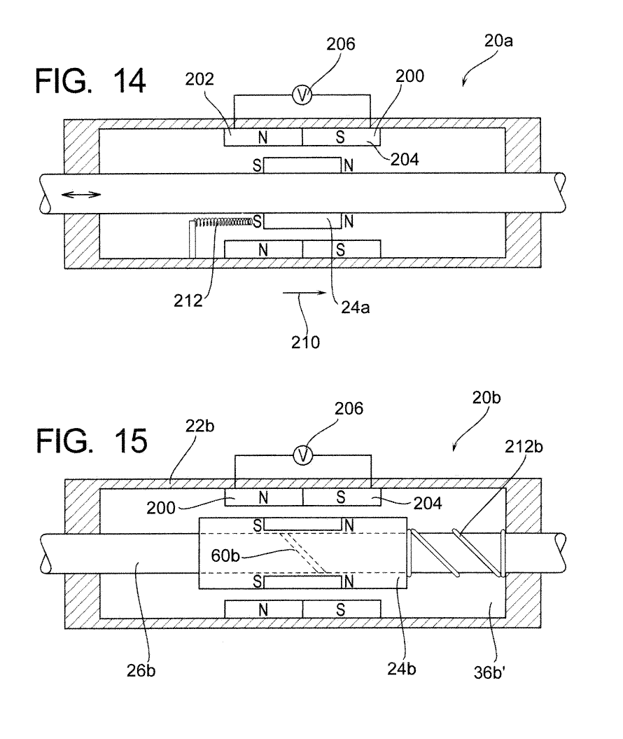

Now referring to FIG. 14, there is showing another embodiment where the device 20a can be utilized with electromagnetic waves so as to induce motion. As schematically shown in FIG. 14, a magnet system 200 can for example have north and south pole regions 202 and 204. This could be an electromagnet having a voltage supply 206 with a coil system to induce such magnetic poles. The piston 24a can in turn have a polarity so as to induce motion of the piston 24a. The piston 24a would for example reposition in the direction indicated by arrow 210, and a biasing member 212 could reposition the piston in the opposing direction, whereby the voltage and corresponding amperage from the supply 206 could be reduced to reduce the magnetic flux field, and the biasing member 212, which could possibly be a spring member, would reposition the piston toward the first longitudinal direction. Of course, as shown in FIG. 14, the biasing member 212 is shown schematically and would for example be a tension member, but of course could be positioned at other regions and be a compression type of member such as a compression helical spring. Therefore, it can be appreciated that the magnetic motor element would operate in repositioning the piston as well as (as shown in FIG. 15) inducing rotation upon the shaft 26b. As shown in FIG. 15, the device 20b is provided with the voltage supply 206 as well as the magnet system 200, with the magnetic pole regions 204 and 206. In this form, the raceway 60b would operate under a similar principle as that described above, and would engage the track engaging member of the piston. Or, vice versa: the raceway could be part of the piston and the track engaging member would be positioned on the shaft. In this form, as the piston 24b oscillates, the shaft 26b will rotate. Further shown in this embodiment is a biasing member 212b, which in this form (for example) could be a helical spring positioned around the shaft 26b and positioned directly in the second region 36b′ of the interior chamber of the casing 22b. The magnets on the piston could, for example, be permanent magnets, or other types of arrangements could be utilized, such as switching the polarity and the casing to induce a motion.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A rotating-to-translating motion converter comprising:
a. a casing having an interior surface defining an interior chamber with first and second regions,
b. a valve system provided to communicate with the first and second regions;
c. a piston operatively configured to be positioned in the interior chamber of the casing and translate therein about a longitudinal axis, the piston being in engagement with the casing so as to not rotate therein, the piston having an annular seal engaging the interior surface of the casing so as to maintain a pressure differential between the first and second chamber regions of the casing;
d. a shaft extending through the casing, the shaft having a raceway position therearound the shaft in a loop along an elliptical path in the longitudinal direction;
e. a rotating seal in engagement with the shaft and operatively configured to rotate therewith, the rotating seal member in engagement with a ring member that is sealingly engaged to the piston whereby the interface between the rotating seal and the ring member provides a pressure differential seal, and further the engagement between the rotating seal member and the shaft provides a seal,
f. a track engaging member positioned on the piston in a manner to engage the raceway of the shaft wherein rotation of the shaft induces a translating motion of the piston within the casing
g. a valve system providing communication with the first and second regions of the chamber so as to provide communication therein.

2. The rotating-to-translating motion converter as recited in claim 1 where the interior chamber is of a cylindrical design.

3. The rotating-to-translating motion converter as recited in claim 1 where the interior chamber is of an elliptical design.

4. The rotating-to-translating motion converter as recited in claim 1 where a plurality of raceways are positioned on the shaft;

5. The rotating-to-translating motion converter as recited in claim 1 where three track engaging members are attached to the piston and configured to engage the raceway of the shaft.

6. The rotating-to-translating motion converter as recited in claim 5 where the three track engaging members are positioned 120° apart from one another to be intermittently used to engage the raceway.

7. The rotating-to-translating motion converter as recited in claim 1 where a piston engaging member is attached to the casing and in engagement with the piston so as to inhibit rotation about the longitudinal axis of the piston with respect to the casing.

8. An energy conversion device having a longitudinal axis, the energy conversion device comprising:
a. a casing having an interior chamber with first and second regions, the casing having a piston limiting feature;
b. a piston operatively configured to be positioned in the interior chamber of the casing and oscillate therein, where the piston limiting feature of the casing inhibits rotation of the piston about the longitudinal axis;
c. a seal member positioned on the casing to maintain a pressure differential between the first and second regions of the interior chamber;
d. a shaft positioned through the piston and configured to rotate therein,
e. a raceway and track engaging member configured to operate between the shaft and the piston where the raceway is a substantial elliptical pattern having a directional component in the longitudinal direction and the track engaging member is configured to follow the path of the raceway wherein rotation of the shaft with respect to the piston creates a translating motion of the piston within the interior chamber of the casing, and a seal system adjacent to the shaft is configured to have a rotating element that rotates with the shaft to provide a seal as the piston oscillates back and forth along the shaft.

9. The energy conversion device as recited in claim 8 where the raceway is positioned on the shaft.

10. The energy conversion device as recited in claim 8 where the raceway is positioned on an interior cylindrical surface of the piston.

11. The energy conversion device as recited in claim 8 where the rotating element rotating with the shaft to provide a seal is positioned adjacent to a ring, whereas a seal ring is configured to provide a rotating seal.

12. A device comprising:
a. a casing having a first and second portion, the casing having an interior surface defining an interior chamber, an opening being positioned in the first portion, the casing providing for an entry passage to the interior chamber;
b. a shaft passing through the opening in the first portion of the casing, the shaft operatively configured to rotate with respect to the casing;
c. a piston member having a central open bore region configured to have the shaft position therethrough, the piston operatively configured to oscillate within the casing so as to reposition in a longitudinal direction therein with respect to a prescribed amount of rotation of the shaft.

13. The device as recited in claim 12 where an elliptical path slot is positioned on the shaft, and an extension from the piston is configured to engage in the slot so as to transfer force between the piston and shaft so rotation of the shaft induces an oscillating and reciprocating motion in the piston.

14. The device as recited in claim 12 where an elliptical path slot is positioned on the central open region of the piston and an extension of the piston engages the elliptical slot so as to transfer force therebetween to transform motion between the piston and shaft wherein oscillating motion and longitudinal direction of the piston correlate to a prescribed amount of rotation of the shaft.

15. The device as recited in claim 12 where the outer surface of the piston is cylindrical, and the interior surface of the casing is a hollow cylindrical surface where a seal is positioned between the piston and the casing so as to maintain a pressure differential between a first and second interior chamber region.

16. The device as recited in claim 12 where a rotating seal member rotates on the shaft, and the rotating seal member will oscillate in a longitudinal direction about the shaft.

17. The device as recited in claim 16 where a ring member is in engagement with the rotating seal member and the ring member is fixedly attached to the piston.

18. The device as recited in claim 17 where magnetic seal members are utilized to provide a magnetic seal force between the rotating seal member and the ring member.

19. The device as recited in claim 12 where the casing is provided with an electromagnet and a permanent magnet is fixed upon the piston so as to induce translating motion thereon.

20. The device as recited in claim 19 where a biasing member will store energy as the piston is biased by an electromagnetic force in a first direction and the biasing member will return energy to reposition the piston in an opposing direction to the first direction.
